(19) United States
(12) Patent Application Publication
(10) Pub. No.: US 2016/0222947 A1
(43) Pub. Date: Aug. 4, 2016

(54) POWER PLANTS WITH AN INTEGRALLY GEARED STEAM COMPRESSOR

(71) Applicant: NUOVO PIGNONE SRL, Florence (IT)

(72) Inventors: Kalyankumar VENKATACHALAM, Bangalore (IN); Adi Narayana NAMBURI, Bangalore (IN); Rakesh GOVINDASAMY, Bangalore (IN); Sharath SATHISH, Bangalore (IN)

(21) Appl. No.: 15/029,317

(22) PCT Filed: Oct. 10, 2014
(86) PCT No.: PCT/EP2014/071796

§ 371 Date: Apr. 14, 2016

(30) Foreign Application Priority Data
Oct. 14, 2013 (IT) FI2013A000238

(51) Int. Cl. F03G 6/06; H02K 7/18

(52) U.S. Cl. CPC F03G 6/065; H02K 7/1823

(57) ABSTRACT

The power plant comprises an integrally geared vapor compressor arrangement, comprised of a bull gear and a compressor shaft with a pinion meshing with the bull gear. The plant further comprises a vapor source, fluidly connectable with an inlet of the integrally geared vapor compressor arrangement. A vapor turbine arrangement is fluidly connectable with an outlet of the integrally geared vapor compressor arrangement for receiving a stream of compressed and superheated vapor from the integrally geared vapor compressor arrangement. An electric generator driven by the vapor turbine arrangement converts mechanical power produced by the vapor turbine arrangement into electric power.

### CROSS-REFERENCE TO RELATED APPLICATIONS

This application is a national stage application under 35 U.S.C. § 371(c) of prior filed, co-pending PCT application Ser. No. PCT/EP2014/071796, filed on Oct. 10, 2014, which claims priority to Italian patent application serial number FI2013A000238, titled “POWER PLANTS WITH AN INTEGRALLY GEARED STEAM COMPRESSOR”, filed Oct. 14, 2013. The above-listed applications are herein incorporated by reference.

### BACKGROUND OF THE INVENTION

Embodiments of the subject matter disclosed herein generally relate to power plants and systems. Some embodiments relate to concentrated solar thermal power plants and systems for their operation. Other embodiments relate to plants for converting thermal energy into useful mechanical or electric energy.

Conventional solar thermal power technologies generally include collectors that focus the energy from the sun so that the high pressure and temperature needed for efficient power generation may be obtained. Different kinds of collectors are known in the art. They usually are combined to form a so-called solar field, wherein a plurality of collectors concentrate the solar energy in a heat collecting circuit, wherein a heat transfer fluid or heat transfer medium circulates, said medium transferring the collected thermal energy into a thermodynamic cycle.

For example, the collected solar thermal energy can be used in a Rankine cycle to generate mechanical power, which can optionally be converted into electrical power by an electric generator.

The efficiency of the thermodynamic cycle depends upon the available solar thermal energy and in particular upon the pressure and temperature conditions, which can be achieved in the thermodynamic cycle.

The power, which can be collected by the solar field, is strongly dependent upon the weather conditions as well as from the position of the sun during the day. In some embodiments of the prior art heat collecting and storing means are used for storing excess thermal energy available during the central part of the day, which can be used to improve the overall efficiency of the thermodynamic cycle during periods where less solar energy is available. This notwithstanding, the solar thermal power plants must be turned off for several hours a day due to insufficient solar power availability or lack of solar power, e.g. at night and during sunrise and sunset.

FIG. 1 illustrates a concentrated solar thermal power plant 1 of the current art. Solar energy is collected by a solar field schematically shown at 3. The solar field 3 can be comprised of a plurality of solar concentrators 5, for example in the form of parabolic troughs, focusing the solar energy on pipes 5A arranged in the focus of the troughs and made of heat conducting material, wherein a heat transfer medium flows. The pipes 5A collecting the thermal energy from individual rows of troughs 5 merge in a duct 7. The heat transfer medium flowing in the duct 7 delivers thermal energy to a system, where thermal power is converted into mechanical power, e.g. via a thermodynamic cycle, such as a Rankine cycle by means of a steam turbine.

A plurality of heat exchangers 9, 11, 13, 15, arranged in sequence are used to transfer thermal energy from the heat transfer medium to a working fluid of a thermodynamic cycle. The heat exchanger 9 is a super-heater, where a working fluid circulating in a closed circuit 17 is superheated. The heat exchanger 11 is a steam generator, where the working fluid is transformed from a liquid phase to a saturated vapor phase. If the working fluid is water, the vapor is water vapor, i.e. steam. The heat exchanger 13 forms part of a solar pre-heater, wherein the working fluid is pre-heated in the liquid phase before being transformed into steam or vapor.

The heat exchanger 15 forms part of a solar re-heater, which is used to re-heat the steam or vapor circulating in the closed circuit 17 between a first expansion step and a second expansion step performed into sequentially arranged high-pressure steam or vapor turbine 19 and low-pressure steam or vapor turbine 21. The heat transfer medium entering the re-heater is at the same temperature as the heat transfer medium entering the super-heater 9 and connection between the duct 7 and the re-heater 13 is through a bypass line 7A.

A return duct 23 returns the heat transfer medium or heat transfer fluid from the heat exchangers towards the solar field. An expansion vessel 24 is provided upstream of the return duct 23.

A bypass line 25 is provided, through which part or the entire heat transfer medium flow can be diverted when the thermal energy collected by the solar field 3 is higher than the thermal energy required by the circuit 17 and/or when the thermodynamic cycle is shut down for whatever reason. Heat contained in the heat transfer medium flowing through the bypass line 25 can be transferred in a heat exchanger 27 to a heat storing medium, e.g. a salt, collected in a hot-salt storage tank 29. When the thermal energy collected by the solar field 3 is insufficient to run the thermodynamic cycle in circuit 17, supplemental heat can be provided by the hot salt stored in storage tank 29, by pumping the hot salt from the storage tank 29 to a cold-salt storage tank 31 via the heat exchanger 27, where thermal energy is transferred by indirect heat exchange from the heat-storage salt to the heat transfer medium circulating in by-pass line 25.

The working fluid circulating in the circuit 17 usually performs a so called Rankine cycle and is usually water. In some embodiments the Rankine cycle can be an Organic Rankine Cycle, using an organic fluid, e.g. cyclopentane.

The working fluid delivered by the super-heater 9 is in a superheated gaseous state and is firstly expanded in the high-pressure turbine 19 and subsequently further expanded in the low-pressure turbine 21. Between the first expansion and the second expansion the working fluid can be re-heated by circulating the working fluid in a circuit 33, including the solar re-heater 15. The two turbines 21 and 19 can be used to drive an electric generator 22, which can in turn deliver electric power to an electric distribution grid schematically shown at G.

Spent and optionally partly condensed steam or vapor from the low-pressure turbine 21 is condensed in a condenser 35 and possibly pre-heated in a low-pressure pre-heater 37 by means of heat exchange with a side flow of the partially expanded vapor or steam, which bleeds from an intermediate stage of the low-pressure turbine 21, for example. A circulating pump 39 pumps the working fluid to a de-aerator 41. A feed water pump 40 pumps the working fluid from the de-aerator 41 through the solar pre-heater 13, the steam generator 11 and the super-heater 9.

FIG. 2 shows a typical steam turbine arrangement with a high-pressure steam turbine 19 and a low-pressure steam turbine 21 connected to one another through a gearbox 20. Reference number 15 designates again a re-heater. If the solar field does not provide sufficient energy to run the thermodynamic cycle at the minimum load conditions, the thermodynamic cycle must be shut down.

There is a need for improving the efficiency of concentrated solar power plants of the current art, especially when the available solar energy is below a minimum threshold and insufficient to superheat the steam.

### SUMMARY OF THE INVENTION

According to some embodiments, a power producing system is provided, comprising at least one integrally geared compressor arrangement, comprised of a bull gear and a compressor shaft with a pinion meshing with said bull gear. A vapor source is fluidly connectable with an inlet of the integrally geared compressor arrangement, to provide vapor to the integrally geared compressor arrangement. A vapor turbine arrangement is configured for receiving a stream of compressed and superheated vapor from the integrally geared compressor arrangement. The vapor turbine arrangement converts at least part of the energy contained in the vapor into useful energy, in form of mechanical energy. In some embodiments an electric generator driven by the vapor turbine arrangement can further convert at least part of the mechanical power produced by the vapor turbine arrangement into electric power. In some embodiments the electric generator can be co-axial with the bull gear of the integrally geared compressor arrangement and driven thereby. In other embodiments, the electric generator can be coaxial with the vapor turbine arrangement and driven thereby.

A main driver or prime mover can be provided for rotating the bull gear of the integrally geared compressor arrangement. In some embodiments the prime mover can be an electric motor.

In some embodiments the prime mover driving the bull gear can be co-axial with the bull gear. For instance, an electric motor can be provided with a driving shaft connectable with a shaft of the bull gear, e.g. through a clutch.

In other embodiments, the prime mover can be a vapor turbine, e.g. the above mentioned vapor turbine arrangement. For instance, the vapor turbine arrangement can be drivingly connected with the bull gear, such that mechanical power produced by the vapor turbine arrangement drives into rotation the bull gear of said integrally geared compressor arrangement.

The vapor turbine arrangement can comprise one or more turbines or turbine stages. In some embodiments the vapor turbine arrangement can comprise a high-pressure vapor turbine and a low-pressure vapor turbine. Vapor re-heating can be provided between the high-pressure vapor turbine and the low-pressure vapor turbine.

The vapor turbine arrangement can be mechanically disconnected from the integrally geared compressor arrangement, in the sense that no drive connection therebetween is provided. In other embodiments, the vapor turbine arrangement can comprise at least one vapor turbine or at least one vapor turbine stage, which is comprised of a turbine shaft drivingly connected with the integrally geared compressor arrangement. For instance, the turbine shaft can be drivingly connected with the bull gear of the integrally geared compressor arrangement. In some embodiments, the turbine shaft is comprised of a pinion mounted thereon, which meshes with the bull gear of the integrally geared compressor arrangement. The rotary speed of the turbine shaft can be different from the rotary speed of the bull gear. In other embodiments, the vapor turbine arrangement comprises a turbine shaft coaxial with the bull gear and drivingly connected therewith, e.g. through a clutch for selectively connecting the vapor turbine to the bull gear or disconnecting the vapor turbine from the bull gear. In some embodiments a gear box can also be provided between the turbine shaft and the bull gear, so that also in this case the rotary speed of the vapor turbine can be different from the rotary speed of the bull gear.

The vapor turbine arrangement can for instance include a main turbine drivingly connected to an electric generator and an auxiliary turbine drivingly connected to the bull gear of the integrally geared compressor. In some embodiments, the vapor source can be selectively connected with the integrally geared compressor arrangement, or with the main turbine, alternatively, for instance depending upon the vapor conditions.

A system as described herein can be used for the production of mechanical and/or electric power from solar energy collected e.g. through a solar collector configured and arranged for transferring solar heat to a liquid for producing vapor. In this case the vapor source is powered by solar energy, e.g. collected by a solar field of a concentrated solar power plant.

According to other embodiments, different heat sources can be used for producing vapor. Any source of waste heat in an industrial plant, for instance, can be usefully exploited for providing vapor. In some embodiments the vapor source is a vapor generator powered by heat from exhaust combustion gases of an internal combustion engine, such as a reciprocating engine, e.g. a diesel engine, or else a gas turbine.

According to a further aspect, the present disclosure concerns a concentrated solar power plant comprising a solar field for collecting solar energy, a vapor turbine system comprising a vapor turbine arrangement receiving superheated vapor generated by heating a working fluid circulating in the vapor turbine system and a thermal transfer system configured for transferring solar thermal energy from said solar field to said vapor turbine system. The system can further comprise an integrally geared compressor arrangement, configured for superheating the vapor when the solar thermal energy from the solar field is insufficient to generate sufficient superheated vapor.

The integrally geared compressor arrangement can be driven by an electric motor and/or by the vapor turbine arrangement, arranged for receiving compressed vapor from said integrally geared compressor arrangement. For instance, a main turbine arrangement can be provided for driving an electric generator and an auxiliary vapor turbine can be provided, which is arranged for receiving compressed vapor from the integrally geared compressor arrangement.

Generally, vapor of any fluid can be used, e.g. an organic fluid. In some embodiments the fluid is water and the vapor is steam.

The vapor turbine system can comprise a Rankine cycle system.

In some embodiments, the solar plant can comprise a heat transfer medium circuit receiving thermal energy from the solar field and a separate working fluid circuit, wherein a working fluid is circulated and caused to undergo a cyclic thermodynamic transformation, e.g. according to a Rankine cycle. A heat exchanger arrangement can be provided, configured and arranged for transferring thermal energy from a heat transfer medium, circulating in the heat transfer medium circuit, to the working fluid. In other embodiments, heat is collected in the solar field directly by the working fluid, which is processed through the vapor turbine.

The heat exchanger arrangement can comprise one or more heat exchangers, such as a vapor generator and a super-heater.

The working fluid circuit can comprise a secondary circuit configured and arranged for selectively diverting the working fluid from the heat exchanger arrangement through the integrally geared compressor arrangement and therefrom to said vapor turbine arrangement, for instance if the solar field does not provide sufficient solar energy for superheating the vapor.

According to yet a further embodiment, the disclosure concerns a method for producing useful power from heat, comprising the steps of: circulating a working fluid in a closed circuit; heating said working fluid to generate compressed vapor; superheating said vapor by means of an integrally geared compressor arrangement; expanding said superheated vapor in a vapor turbine arrangement and producing useful power therewith.

According to a further aspect, the present disclosure concerns a method of operating a concentrated solar power plant, comprising the steps of: collecting solar thermal energy with a solar field; generating superheated vapor by heating a working fluid with said solar thermal energy; expanding said superheated vapor in a vapor turbine arrangement and generating mechanical power therewith; supplementing said solar thermal energy with supplemental energy delivered by an integrally geared compressor arrangement for superheating vapor delivered to said vapor turbine arrangement, when said solar thermal energy is insufficient to generate sufficient superheated vapor.

According to some embodiments, the method disclosed herein further comprises the following steps:

circulating a heat transfer medium in a first circuit for transferring solar thermal energy from said solar field to a second circuit;

circulating a working fluid in said second circuit, said working fluid performing a thermodynamic cycle to convert at least part of said solar thermal energy into mechanical energy in said vapor turbine arrangement;

processing said working fluid in said integrally geared compressor arrangement for supplementing energy to said working fluid, when the solar thermal energy is insufficient to generate sufficient superheated vapor.

Here below reference will specifically be made to a system using water and steam, i.e. water vapor. However, the present disclosure more generally refers to a system where any suitable working fluid can be used. For example, the system and method of the present disclosure can be based on an organic Rankine cycle using an organic working fluid. Suitable working fluids can be pentane, cyclopentane or other hydrocarbons having suitable properties.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a concentrated solar power plant according to the current art;

FIG. 2 illustrates a typical reheat steam turbine arrangement for a concentrated solar power plant with a high-pressure steam turbine working with superheated steam;

FIG. 3 illustrates a first embodiment of a concentrated solar power plant according to the present disclosure;

FIGS. 3A and 3B illustrate two possible embodiments of solar concentrator arrangements for a concentrated solar power plant according to the present disclosure;

FIG. 4 illustrates the pressure-enthalpy diagram for a concentrated solar power plant using a modified Rankine cycle according to the present disclosure;

FIG. 5 illustrates a temperature-entropy diagram for the modified Rankine cycle according to the present disclosure in a simplified arrangement;

FIG. 6 illustrates a diagram similar to the diagram of FIG. 5, showing a reheated cycle;

FIG. 7 illustrates a further embodiment of a concentrated solar power plant according to the present disclosure;

FIG. 8 illustrates yet a further embodiment of a concentrated solar power plant according to the present disclosure;

FIG. 9 illustrates a further embodiment of a power plant according to the present disclosure.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

In the following detailed description of some embodiments, the plant uses a thermodynamic cycle based on the Rankine cycle using water and steam as a working fluid. In other embodiments, as noted above, however, a different working fluid can be used. The operative method will be substantially the same, except that instead of steam, vapor of such different working fluid will be generated and processed.

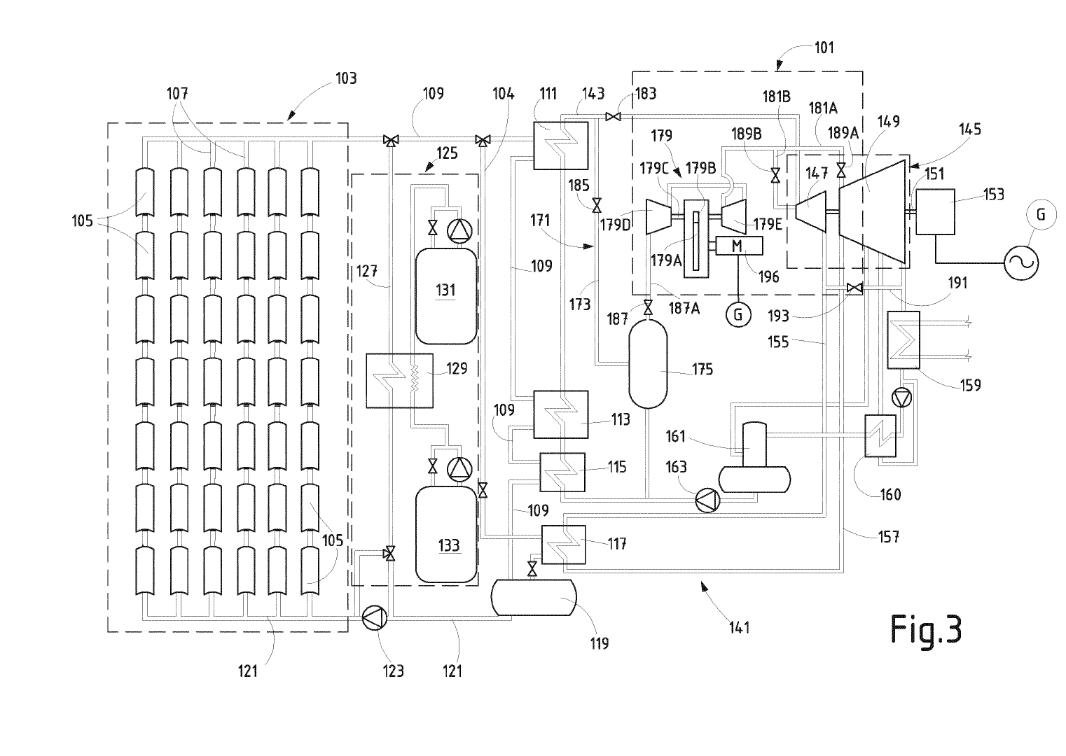

Referring to FIG. 3, the main components of a concentrated solar power plant 101 according to the present disclosure will be described. The concentrated solar power plant 101 comprises a solar field 103. The solar field 103 comprises a plurality of solar concentrators 105. In the schematic diagram of FIG. 3 a solar field 103 comprising a plurality of trough concentrators 105 is schematically represented. The concentrators focus the solar energy on a plurality of pipes 107, which are located in the focus of the parabolic troughs 105. FIG. 3A illustrates by way of example one such solar concentrator 105, which includes a parabolic mirror 105A, in the focus point whereof the pipe 107 is arranged. A heat transfer fluid flowing in the pipe 107 is thus heated by means of the solar energy, which is collected by the trough 105A.

In a manner known to those skilled in the art, the solar field 103 usually comprises a large number of solar concentrators 105 arranged in rows, each row being provided with one pipe 107 for collecting the thermal energy in the heat transfer medium flowing in the pipes 107. The troughs 105A are controlled to track the sun during the day so as to collect the maximum radiant energy.

In other embodiments the solar field 103 can be designed differently. FIG. 3B illustrates by way of example a solar field 103 comprising a plurality of planar mirrors 106, which are arranged so as to focus the solar energy in an area 108 on top of a tower 110. In the area 108 a heat exchanger is provided, through which the heat transfer medium circulates, in order to be heated by the solar energy focused by the mirrors 106. The mirrors 106 are motor-controlled to track the sun in order to maximize the solar energy concentrated on the area 108.

In some embodiments, as shown in FIG. 3, heat collected by the heat transfer medium circulating through the solar field 103 is transferred to as separate circuit, where a second fluid circulates and performs a thermodynamic cycle. The solar heat is thus transferred from a primary circuit, where the heat transfer fluid circulates without undergoing any thermodynamic transformation, to a secondary circuit, where a different fluid undergoes thermodynamic transformations to convert the heat energy into useful mechanical and/or electrical energy. The possibility is not excluded of using one and the same closed circuit where a single fluid circulates, collects heat from the solar field, is transformed into pressurized vapor, expands in an expander or turbine, condenses in a condenser and is pumped in the liquid phase back to the solar field.

In FIG. 3, the pipes 107 are collected in a delivery duct 109, which delivers the heated heat transfer medium from the solar field 103 through a heat exchanger arrangement. In some embodiments the heat exchanger arrangement comprises a series of heat exchangers, which will be referred to as a solar super-heater 111, a steam (i.e. water vapor) generator or evaporator 113 and a solar pre-heater 115. In other embodiments, not shown, two or more of the above mentioned heat exchangers can be combined to a single heat exchange arrangement or unit.

According to some embodiments, a solar re-heater 117 is further provided, through which a fraction of the heat transfer medium, flowing in a bypass line 104 is delivered. The heat transfer medium flowing in line 104 bypasses the solar super-heater 111, the steam generator 113 and the solar pre-heater 115. In other embodiments, no re-heater is provided.

In the serially arranged heat exchangers 111-115 the heat transfer medium transfers thermal energy at progressively lower temperatures to a working fluid circulating in a closed circuit 141, which will be described later on, wherein the working fluid performs a thermodynamic cycle, for example a Rankine cycle, to convert thermal energy or heat into mechanical energy and eventually into electric energy.

After passing through the heat exchangers, the cooled heat transfer medium is collected in an expansion vessel 119 and pumped by a pump 123 along a return duct 121 back into the solar field 103 again.

In some embodiments, an intermediate thermal energy storage arrangement 125 can be provided, for storing excess thermal energy available from the solar field 103.

In some embodiments the thermal energy storage arrangement 125 can include a bypass line 127 receiving hot heat transfer medium from delivery duct 109 and delivering it through a heat exchanger 129, wherein thermal energy is transferred to a heat storage medium, which flows from a low-temperature tank 133 to a high-temperature tank 131. Thermal energy stored in the high-temperature tank 131 is returned back to the hot transfer medium by means of the heat exchanger 129, when required, e.g. when less solar energy is collected by the solar field 103.

The heat transfer medium, therefore, circulates in a closed loop or circuit comprising the solar field 103, the hot side of the heat exchanger arrangement including the solar super-heater 111, the steam generator 113, the solar pre-heater 115, the solar re-heater 117, the delivery duct 109 and the return duct 121.

The thermal energy collected by the solar field 103 is transferred by the heat transfer medium through the heat exchangers 111-117 to a second closed circuit 141, wherein the working fluid circulating therein performs a thermodynamic cycle and converts the thermal energy into mechanical power.

The closed circuit 141 includes the cold side of the solar super-heater 111, the steam generator 113, the solar pre-heater 115 and the solar re-heater 117.

Superheated steam delivered by the solar super-heater 111 flows through a duct 143 towards a steam turbine arrangement 145.

In some embodiments the steam turbine arrangement 145 comprises a first, high-pressure steam turbine 147 and a second, low-pressure steam turbine 149, arranged in sequence and including respectively a high-pressure rotor and a low-pressure rotor. The high-pressure rotor of the high-pressure steam turbine 147 and the low-pressure rotor of the low-pressure steam turbine 149 can be mounted on a common turbine shaft 151.

The turbine shaft 151 can be linked to an electric generator 153, which converts mechanical power available on the turbine shaft 151 into electric power, which can be delivered to an electric distribution grid G.

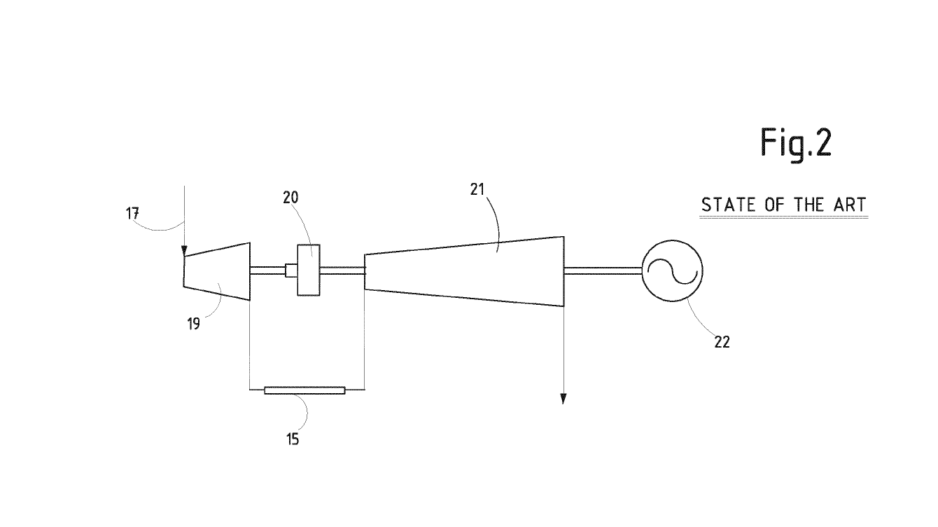

In some embodiments, the low-pressure turbine 149 and the high-pressure steam turbine 147 can rotate at different rotary speeds, as illustrated by way of example in FIG. 2. In this case a gearbox or another speed manipulation device is usually arranged between the high-pressure rotor shaft and the low-pressure rotor shaft. The shaft line formed by the two rotors and the gearbox arranged there between is then connected at one end to the electric generator 153.

In some embodiments the steam is partly expanded in the high-pressure steam turbine 147 and subsequently delivered to the solar re-heater 117 through a duct 155. In the solar re-heater 117 the partly expanded steam is reheated and the reheated steam is delivered through a duct 157 to the inlet of the low-pressure steam turbine 149.

Spent steam exiting the steam turbine arrangement 145 is condensed in a condenser 159 and finally delivered through a de-aerator 161 and to the solar pre-heater 115.

In some embodiments a low-pressure pre-heater 160 can be arranged along the flow path of the condensed working fluid between the condenser 159 and the de-aerator 161. In the low-pressure pre-heater 160 the low-pressure condensed working fluid is pre-heated exchanging heat against a side-stream of steam bleeding from an intermediate stage of the low-pressure steam turbine 149.

A pump 163 boosts the pressure of the water or condensed working fluid collected in the de-aerator 161 to the required upper pressure and delivers the pressurized working fluid in the liquid phase through the solar pre-heater 115. From the solar pre-heater 115 the heated working fluid, still in the liquid phase, is delivered through the steam generator 113 where it is vaporized and converted into saturated steam. The saturated steam is finally superheated in the solar super-heater 111.

The steam turbine system including the steam turbine arrangement 145, along with the piping and heat exchangers, de-aerator 161 and condenser 159 through which the working fluid flows in order to perform the thermodynamic cycle, further comprises a secondary circuit 171. The working fluid can be diverted in the secondary circuit 171, in order to be superheated by means of an integrally geared steam compressor 179, when the thermal energy available from the solar field 103 is insufficient to achieve proper superheated conditions of the working fluid at the outlet of the solar super-heater 111.

In some embodiments the secondary circuit 171 comprises a diverting line 173, which is in fluid communication with the duct 143 leading from the solar super-heater 111 to the steam turbine arrangement 145. The diverting line 173 can be in fluid communication also with a water/steam separator 175. The steam outlet of the water/steam separator 175 can be connected to the inlet of the integrally geared steam compressor 179.

Saturated steam or partly superheated steam from the water/steam separator 175 is delivered to the suction side of the integrally geared steam compressor 179. The integrally geared steam compressor 179 compresses the saturated steam to a pressure, which is sufficiently high to ensure that at the outlet of the integrally geared steam compressor 179 the steam is in a superheated condition suitable for expansion in the steam turbine arrangement 145. The delivery side of the integrally geared steam compressor 179 can be put in fluid communication through a line 181A with the inlet of the low-pressure steam turbine 149 or through a line 181B with the inlet of the high-pressure steam turbine 147. Valves 189A, 189B can be arranged on the lines 181A and 181B for selective connection of the integrally geared steam compressor 179 with either one or the other of the two steam turbines 147, 149. In other embodiments, only the line 181A and the valve 189A can be provided.

In some embodiments the integrally geared steam compressor 179 comprises a bull gear or central gear 179A which can be driven into rotation by an electric motor 196. The electric motor 196 can be powered by the electric distribution grid G, as schematically shown in FIG. 3, or directly by the electric generator 153.

In some embodiments the integrally geared steam compressor 179 can comprise a plurality of stages. In the schematic representation of FIG. 3 only a first stage 179D and a second stage 179E are shown, but it shall be understood that larger number of stages can be provided.

The rotors of the two stages 179D, 179E can be keyed on a common shaft 179C, which is driven into rotation by the motor 196 via the bull gear 179A and a pinion 179B keyed on the shaft 179C.

In other embodiments, not shown, the integrally geared steam compressor 179 can comprise separate shafts for separate compressor stages. Each shaft can be provided with its own pinion meshing with the bull gear 179A, so that each compressor stage can rotate at a different speed.

In yet further embodiments, the integrally geared steam compressor 179 can comprise more than one shaft, driven by the bull gear 179A. Two rotors of two compressor stages can be mounted on one, some or all the shafts.

One, some or all the compressor stages can be provided with variable inlet guide vanes, for optimal fluid flow control, adapting the operation of the integrally geared steam compressor 179 to the operating conditions, e.g. the steam flow rate available.

As will be described in greater detail here below, the secondary circuit 171 can be selectively connected to the main steam circuit, or isolated therefrom, depending upon the operative conditions of the solar field 103.

Along the duct 143 a first valve 183 can be arranged, which is alternatively opened or closed depending upon the mode of operation of the thermodynamic cycle. A second valve 185 can be provided along the diverting line 173, a third valve 187 can be arranged between the outlet of the water/steam separator 175 and the suction side of the integrally geared steam compressor 179. Further valves 189A and 189B can be arranged along the lines 181A and 181B, as mentioned above, between the delivery side of the integrally geared steam compressor 179 and the inlet of the low-pressure steam turbine 149 and of the high-pressure steam turbine 147, respectively.

A bypass 191 can be provided between the duct 155 and the discharge side of the low-pressure steam turbine 149. A valve 193 can be provided on the bypass line 191. As will be described in greater detail later on, under certain operating conditions the high-pressure turbine 147 is bypassed and only the low-pressure steam turbine 149 is operative. In this case the interior of the high-pressure steam turbine 147 must be placed under vacuum conditions. This is obtained by opening valve 193 and connecting the inoperative high-pressure turbine 147 with the condenser 159 through bypass line 191.

The concentrated solar power plant 101 described so far with reference to FIG. 3 operates as follows.

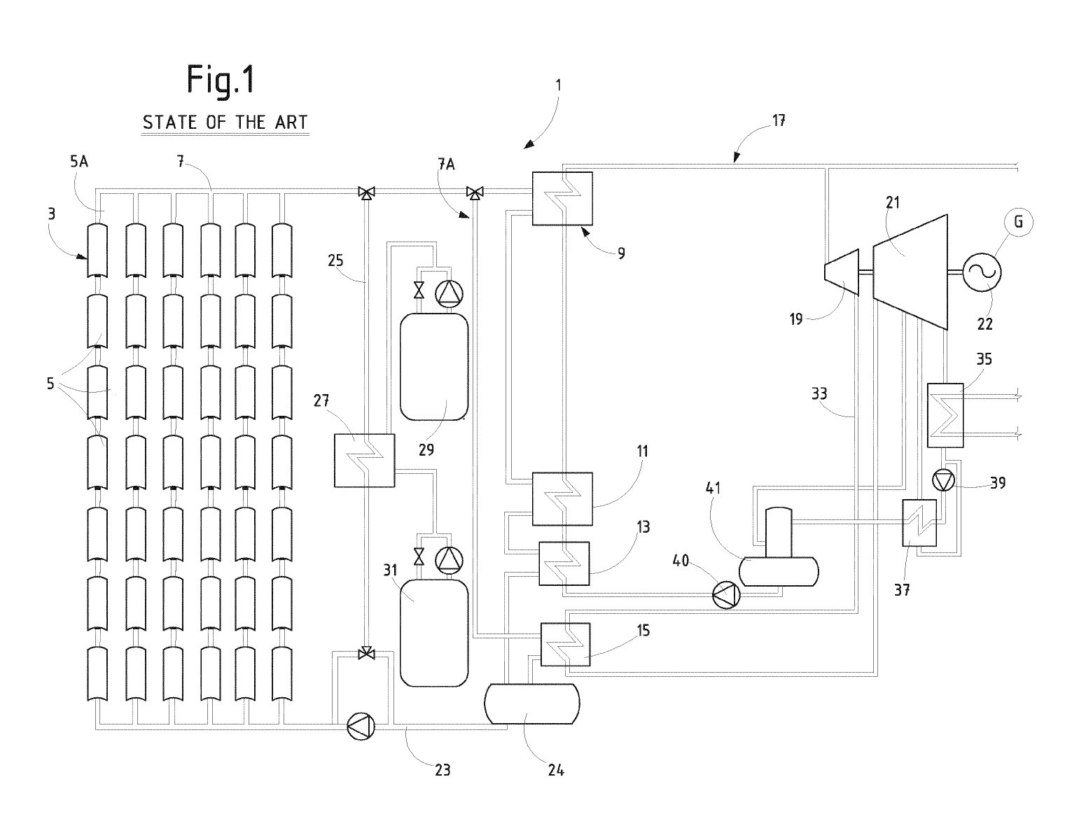

Under normal operating conditions, when sufficient solar energy is collected by the solar field 103, the concentrated solar power plant of FIG. 3 operates substantially in the same way as a plant of the current art (FIG. 1). The thermal energy is extracted from the solar field 103 by the heat transfer medium flowing in the ducts 109, 104, 121 and transferred to the working fluid circulating in the steam turbine system of the second closed circuit 141. The working fluid circulating in the steam turbine system performs a Rankine cycle converting thermal power received from the solar field 103 into mechanical power available on the turbine shaft 151.

The secondary circuit 171 is closed. The valves 185, 187, 189A and 189B are closed, while the valve 183 is opened. The superheated steam flows along duct 143 into the high-pressure steam turbine 147. The partly expanded steam is re-heated in the re-heater 117 and finally expanded in the low-pressure steam turbine 149. The spent steam is condensed in condenser 159 and delivered to the solar pre-heater 115, where the water is heated and subsequently transformed into steam in the steam generator 113 and again superheated in the solar super-heater 111.

If the thermal power available from the solar field 103 is insufficient to generate a suitable flow of superheated working fluid at the outlet of the solar super-heater 111, the steam turbine system is switched to a modified operating mode, wherein the working fluid is superheated using the integrally geared steam compressor 179. The valve 183 is closed, while the valves 185, 187 and at least one of the valves 189A 189B is opened.

Working fluid in a saturated steam condition or in an insufficiently super-heated condition is delivered through the diverting line 173 in the water/steam separator 175. Water is drained from the bottom of the water/steam separator 175 and flows back to the solar pre-heater 115, while saturated steam is delivered through valve 187 and a delivery duct 187A into the integrally geared steam compressor 179. The integrally geared steam compressor 179 introduces energy in the steam by increasing the pressure thereof in a substantially adiabatic compression process. The steam delivered by the steam compressor 179 is therefore in a superheated condition and at a pressure, which is higher than the outlet pressure at the solar super-heater 111. Usually, the compressor delivery pressure is lower than the pressure of the superheated steam delivered by the solar super-heater 111 when the concentrated solar power plant 111 is operating in design conditions, i.e. when the steam is superheated using the solar energy.

The super-heated and partially pressurized steam is delivered through valve 189A to the low-pressure steam turbine 149, by-passing the high-pressure steam turbine 147. If the pressure of the pressurized steam delivered by the integrally geared steam compressor 179 is sufficiently high, the pressurized steam can be delivered to the high-pressure steam turbine 147 through valve 189B.

By flowing through the low-pressure steam turbine 149 (or alternatively through both the high-pressure steam turbine 147 and the low-pressure steam turbine 149) the steam is expanded and the energy contained therein is at least partly converted into mechanical energy available on the turbine shaft 151. Spent steam exiting the low-pressure steam turbine 149 is condensed in the condenser 159 and undergoes the usual further transformations until it is again delivered, in the liquid phase, through the solar pre-heater 115, the steam generator 113 and the solar super-heater 111.

Under these modified operating conditions the re-heater circuit can be inoperative. Depending upon the steam pressure at the delivery side of the integrally geared steam compressor 179, also the high-pressure steam turbine 147 can be inoperative. The valve 183 is closed.

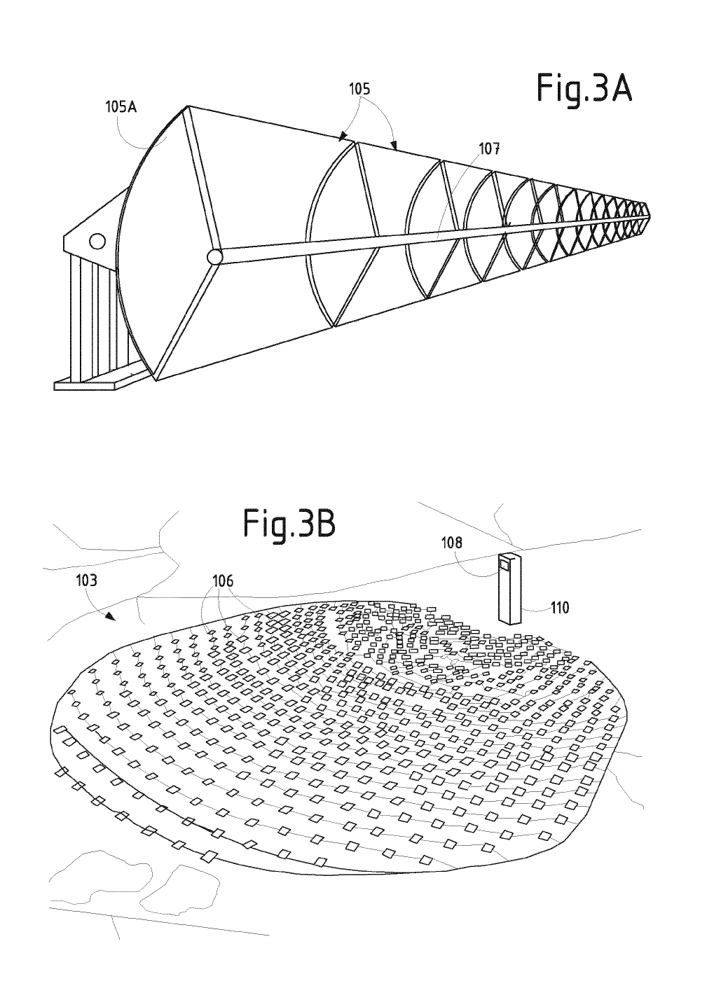

FIG. 4 illustrates a pressure/enthalpy diagram, showing three different operating conditions of the concentrated solar power plant of FIG. 3.

Under normal design conditions the thermodynamic cycle performed by the working fluid in the circuit 141 is represented by points A, B, C, D and E. In an exemplary embodiment the low pressure in the cycle can be around 0.05 bar, said pressure being achieved by the condenser system 159 and the condensate is pumped into the de-aerator by the condensate pump through low-pressure heater(s) 160. The feed pump 163 boosts the fluid pressure from the pressure in the de-aerator 161 to the high cycle pressure of e.g. around 100 bar and the fluid is heated up to point B before starting the water/steam phase change ending at C, said point being on the saturation line. The saturated steam is then superheated reaching point D, which represents the working fluid condition at the output of the solar super-heater 111. Superheated steam is expanded in the steam turbine arrangement 145 from point D to point E. In the schematic diagram of FIG. 4 steam re-heating is omitted.

Under minimum load conditions the Ranking cycle is defined by curve AFGH. An upper working fluid pressure of e.g. around 17.6 bar with superheat, suitable for operation of the high-pressure steam turbine is achieved from saturated steam pressure of about 8 bar. Said upper pressure value is substantially lower than the pressure in design conditions. Sufficient solar energy is available for superheating the steam from point G to point H and the superheated steam is then expanded in the steam turbine arrangement 145. Also in this case re-heating is not represented in the diagram.

If even less solar energy is available, the concentrated solar power plant will not be able to perform a standard Rankine cycle. The plant is therefore switched to the modified operation mode, where supplemental energy is delivered to the working fluid by the integrally geared steam compressor 179. The thermodynamic cycle performed by the working fluid is in this case represented by the curve AIJHE. The cycle is operated at an upper pressure, which can be lower than the minimum operating pressure of the normal cycle, e.g. an upper pressure of around 8 bar.

Between point I and point J of the curve the water is heated and transformed into saturated steam at point J using the solar energy available from the solar field 103. Point J represents the condition of the saturated steam at the outlet of the solar super-heater 111. Under these conditions the super-heater 111 actually operates as a steam generator exchanger, since the steam delivered by the super-heater is in saturated or approximately saturated conditions. AES is the energy provided by the solar field 103. The saturated steam is then delivered through the integrally geared steam compressor 179, and is brought in the condition represented by point H at a higher pressure of, for example, around 17.6 bar in a superheated condition. AEC represents the energy supplied by the integrally geared steam compressor 179. The subsequent steam expansion from point H to point E provides mechanical energy. AET is the useful mechanical energy produced by the low-pressure steam turbine 149.

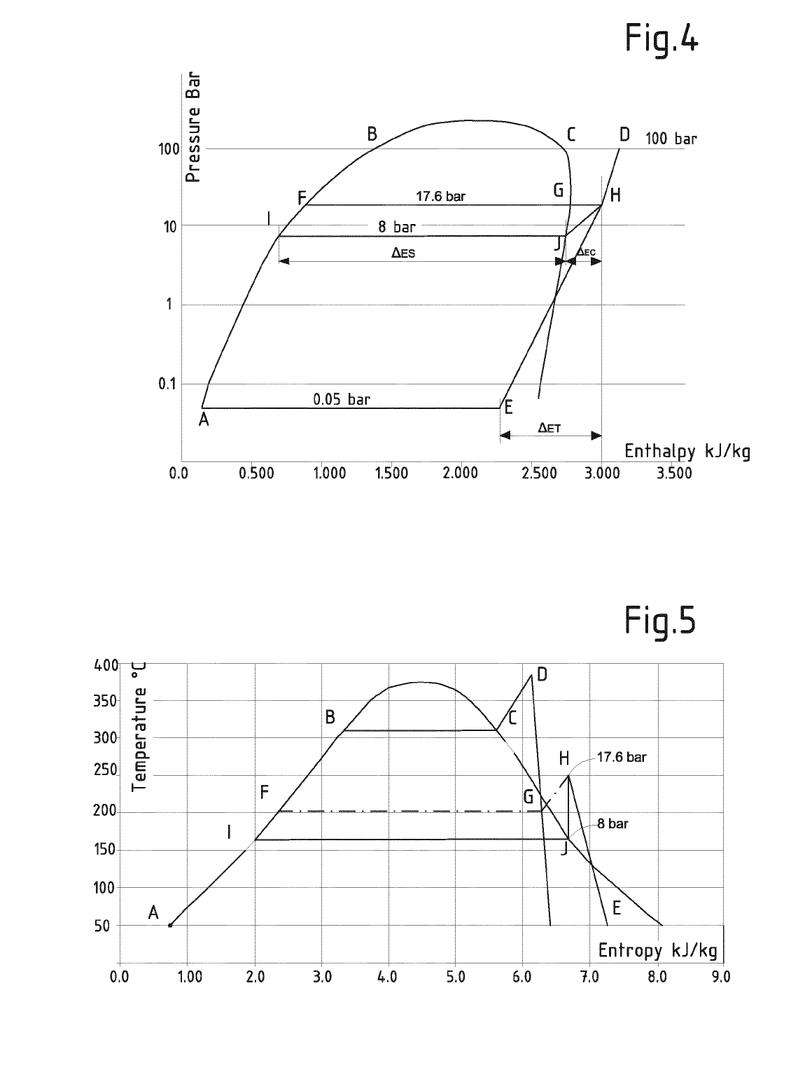

FIG. 5 illustrates the same thermodynamic cycle on a temperature-entropy diagram. Also in this case the reheating step is not shown.

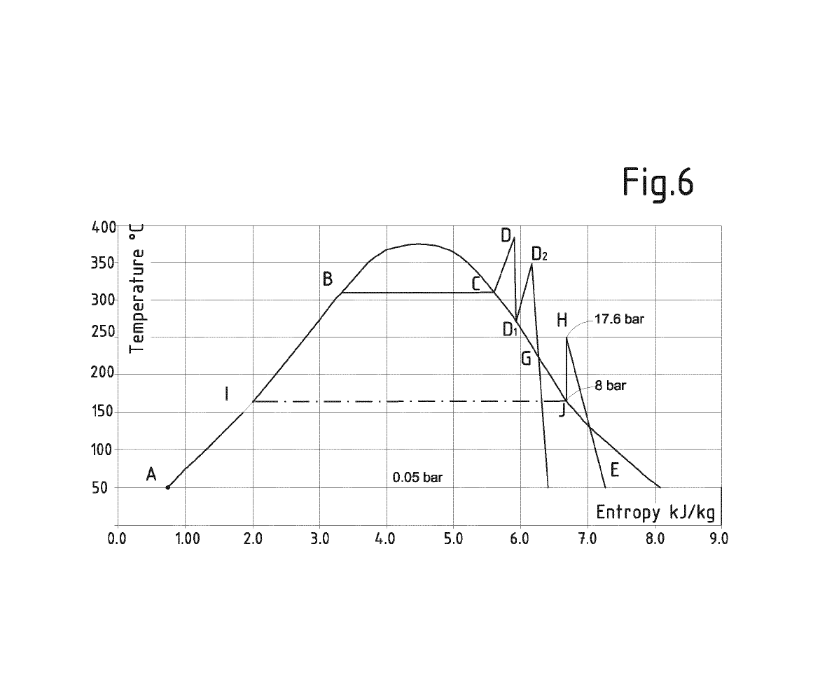

In both diagrams of FIGS. 4 and 5 the thermodynamic cycle has been represented in a simplified embodiment, where no re-heating is provided. The same considerations apply in case of a re-heated cycle. FIG. 6 illustrates the same curves as FIG. 5 in a situation where the normal operating conditions provide for re-heating of the steam after expansion in the high-pressure steam turbine 147. In this case in normal operating conditions, i.e. when the solar field 103 delivers sufficient solar power to superheat the steam in the Rankine cycle, steam is superheated up to point D, expanded in the high-pressure steam turbine 147 to point D1 and then re-heated in the re-heater 117 to reach point D2. From there the re-heated steam is expanded in the low-pressure steam turbine 149 to the low cycle pressure and condensed (point A). Curve A, I, J, H, E illustrates the thermodynamic cycle in the modified operating condition, where superheating (curve JH) is performed by the integrally geared steam compressor 179.

The pressure and temperature values reported in FIGS. 4, 5 and 6 are to be considered as exemplary and not limiting.

In the exemplary embodiment of FIG. 3, the integrally geared steam compressor 179 is used only to superheat the saturated steam when the solar energy is insufficient to run the turbine arrangement with a standard Rankine cycle. In other embodiments the steam compressor 179 can be used also for additional functions. In some embodiments, not shown, the integrally geared steam compressor can be used to boost the pressure of superheated steam, which is then stored in a superheated steam storage tank for subsequent use during transient phases, e.g. when the solar energy collected by the solar field 103 diminishes.

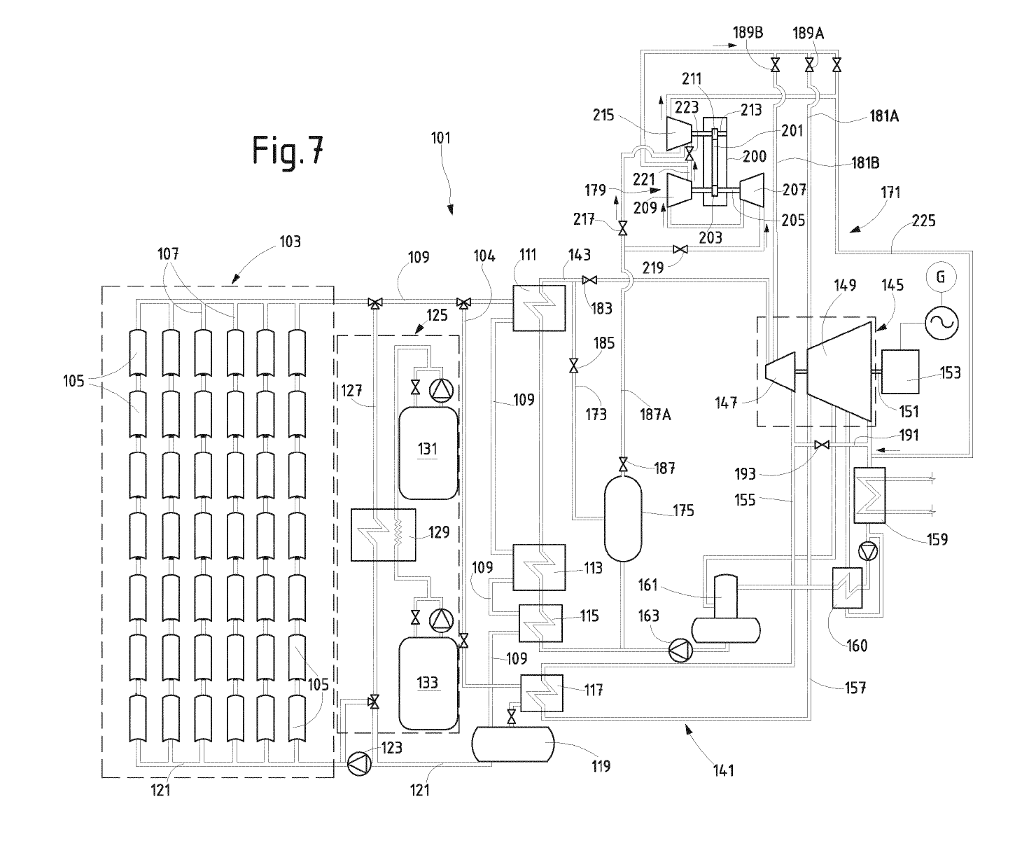

FIG. 7 illustrates a further embodiment of a concentrated solar plant embodying the subject matter disclosed herein. The same elements, components and part already shown in FIG. 3 and described above are labeled with the same reference numbers and will not be described again.

In the embodiment shown in FIG. 7 the integrally geared steam compressor 179 comprises a gearbox 200 comprised of a bull gear 201 and one or more pinions mounted on peripherally arranged shafts.

In some embodiments, a first pinion 203 meshing with the bull gear 201 is mounted on a first shaft 205, driving into rotation one or more stages of the integrally geared steam compressor 179. In some exemplary embodiments, a low-pressure compressor stage 207 and a high-pressure compressor stage 209 are arranged on opposite sides of the shaft 205 and driven thereby. As in the previously described embodiment, each compressor stage comprises an impeller arranged in an overhung arrangement on the respective shaft. Variable inlet guide vanes can be provided for one, some or all the stages of the compressor.

The two compressor stages 207 and 209 are connected in sequence, so that steam entering the first compressor stage 207 is compressed thereby and delivered to the suction side of the second compressor stage 209.

In other embodiments, not shown, more than two compressor stages can be provided, e.g. driven by several shafts and relevant pinions meshing with the bull gear 201, such that each shaft supports one or two overhung impellers.

A further pinion 111 can mesh with the bull gear 201 and is mounted on a shaft 213. The shaft 213 is an output shaft of an auxiliary steam turbine 215. Power generated by the auxiliary steam turbine 215 drives into rotation the bull gear 201 through the pinion 211 and thereby the compressor stages 207 and 209 through the pinion 203 and shaft 205, as well as any other additional shaft and relevant compressor stage(s), not shown, the compressor might be comprised of

The steam outlet of the water-steam separator 275 can be connected through duct 287A and valve 287 selectively to the low-pressure compressor stage 207 or to the auxiliary steam turbine 215. Valves 217 and 219 are provided for selectively connecting the duct 287A to the auxiliary steam turbine 215 and/or to the low-pressure compressor stage 207 respectively.

The delivery side of the high-pressure compressor stage 209 can be fluidly connected selectively with the auxiliary steam turbine 215, with the low-pressure steam turbine 149 or with the high-pressure turbine 147 of the steam turbine arrangement 145. For that purpose a pressurized steam delivery duct 221 can be connected through a valve 223 with the inlet of the auxiliary steam turbine 215 or with an intermediate stage thereof. The delivery duct 221 is further connected to lines 181A and 181B by a valve 189A and 189B respectively, to deliver compressed steam to the low-pressure steam turbine 149 or to the high-pressure steam turbine 147, respectively.

The plant shown in FIG. 7 operates substantially in the same manner as the plant of FIG. 3 when sufficient energy is available from the solar field 103 to generate superheated steam, which is delivered through line 143 to the steam turbine arrangement 145, the bypass valve 185 being closed.

When the steam generated by the heat exchanger arrangement 111-115 is saturated or only partly superheated, due to insufficient solar radiation, for example, the valve 193 is closed and the valve 185 provided on line 173 is opened so that partly superheated or saturated steam is delivered to the water/steam separator 175 as already disclosed in connection with FIG. 3. Water is drained from the bottom of the water/steam separator 175 and recirculated in the liquid branch of the closed circuit 141, while saturated steam or wet steam is delivered through line 187A and valve 187 towards the integrally geared steam compressor 179 and to the auxiliary steam turbine 215.

Depending upon the operating conditions, at least in some transient phases saturated steam from the water/steam separator 175 can be delivered to the auxiliary steam turbine 215 only, maintaining valve 219 closed. The steam is thus used to generate mechanical power through the auxiliary steam turbine 215 and to rotate the bull gear 201 of the integrally geared steam compressor 179.

If sufficient power is available on the auxiliary turbine shaft 213, saturated steam can be delivered to the suction side of the low-pressure compressor stage 207 by opening the valve 219. Power generated by the auxiliary steam turbine 215 is thus used to drive the compressor stages 207, 209 of the integrally geared steam compressor 179, thus increasing the pressure of the steam. Superheated steam is thus delivered at the delivery side of the high-pressure compressor stage 209.

Once the integrally geared steam compressor 179 has been started and sufficiently superheated steam is generated thereby, the valve 217 can be closed and the valve 223 can be opened so that superheated steam delivered by the integrally geared steam compressor 179 is expanded in the auxiliary steam turbine 215 to generate mechanical power, which maintains the integrally geared steam compressor 179 in operation.

Part of the superheated compressed steam delivered by the integrally geared steam compressor 179 can be delivered through line 181A and valve 189A to the low-pressure steam turbine 149 of the steam turbine arrangement 145. Under certain operating conditions, if sufficiently high pressure is achieved at the delivery side of the integrally geared steam compressor 179, the superheated steam can be delivered through line 181B and valve 189B to the high-pressure steam turbine 147 of the steam turbine arrangement 145, at the first or at an intermediate stage thereof, if needed. The superheated steam will then expand in the high-pressure steam turbine 147 and subsequently in the low-pressure steam turbine 149.

In the embodiment of FIG. 7, therefore, supplemental power for superheating the steam to be expanded in the steam turbine arrangement 145 is generated by the same steam delivered by the water/steam separator 175 using the auxiliary steam turbine 215, rather than by an auxiliary electrical motor. In substance, the saturated steam flow delivered by the water/steam separator 175 is split: part of the steam flow is used to generate additional mechanical power to drive the integrally geared steam compressor 179, and part of the compressed and superheated steam is expanded in the steam turbine arrangement 145, to produce useful power which is converted by electric generator 153 into electric power and finally delivered to the electric power distribution grid G.

Spent steam from the auxiliary steam turbine 215 is collected along a line 225 in the condenser 159. Spent steam from the steam turbine arrangement 145 is also collected in the condenser 159 as described above.

The curves representing the modified Rankine cycle performed by plant of FIG. 7 on the pressure-vs.-enthalpy and temperature-vs.-entropy diagrams are substantially the same as shown in FIGS. 4 through 6 described above.

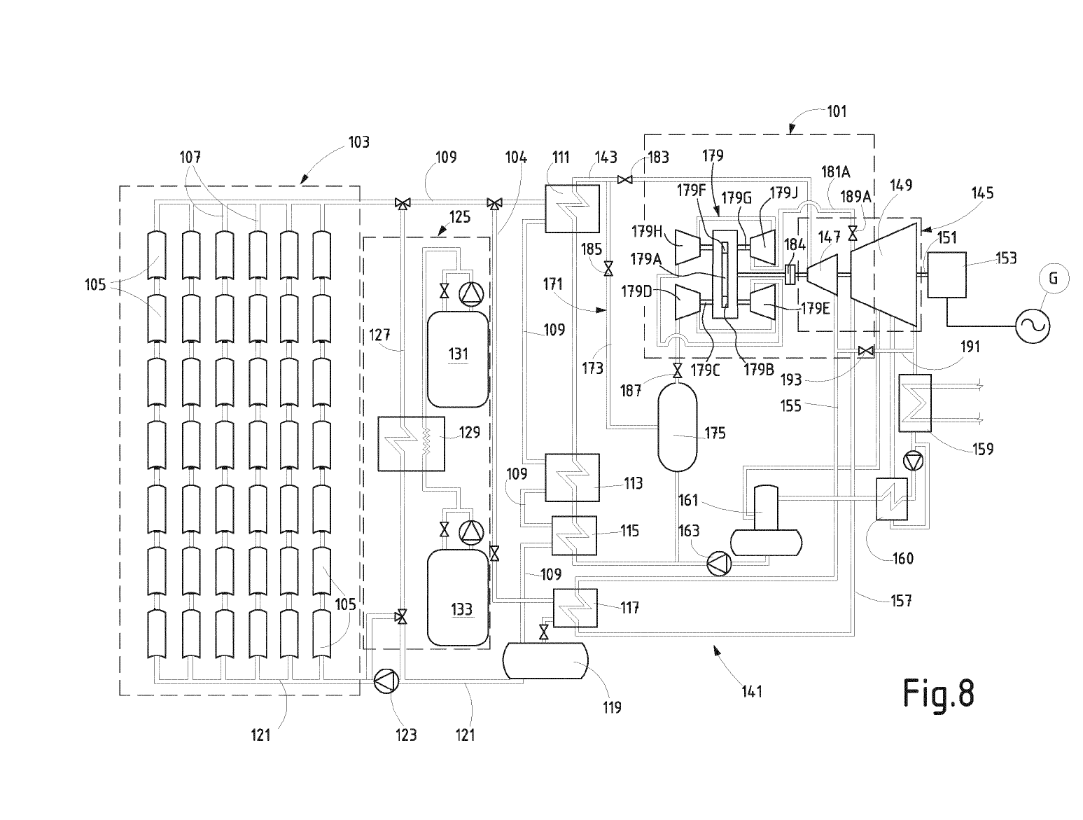

FIG. 8 illustrates a further embodiment of a concentrated solar thermal power plant using an integrally geared steam compressor for superheating the steam when insufficient solar energy is available from the solar field. The same reference numbers as used in FIGS. 3 and 7 indicate the same or equivalent parts, components or elements, which will not be described again.

In the exemplary embodiment of FIG. 8 the integrally geared steam compressor 179 is provided with a bull gear 179A driving into rotation four compressor stages. A first pinion 179B keyed on a shaft 179C meshes with the bull gear 179A and drives into rotation two compressor stages 179D and 179E. A further pinion 179F keyed on a further shaft 179G meshes with the bull gear 179A and drives into rotation two further compressor stages 179H and 179J. The number of stages can clearly be different and the four stages depicted in FIG. 8 are by way of example only. One, some or all the compressor stages can be provided with variable inlet guide vanes as mentioned above.

Saturated or partly superheated steam delivered by the water/steam separator 175 is sequentially processed by the compressor stages 179D, 179E, 179H, 179J and delivered to the steam turbine arrangement 145. In some embodiments the steam can be delivered to the high-pressure steam turbine 147 and expand sequentially in the high-pressure steam turbine 147 and in the low-pressure steam turbine 149. A valve arrangement can be provided for bypassing the high-pressure steam turbine 147 and delivering the steam directly to the low-pressure steam turbine 149, depending upon the steam conditions. In other embodiments a connection of the integrally geared steam compressor 179 to the low-pressure steam turbine 149 only can be provided.

The turbine shaft 151 can be selectively connected to the integrally geared steam compressor 179 or disconnected therefrom, for instance by means of a clutch 184.

The operation of the system illustrated in FIG. 8 when sufficient solar energy is available, is the same as described above with respect to FIG. 3. If insufficient solar energy is available for superheating the steam, saturated or insufficiently (partly) superheated steam or wet steam is delivered through the integrally geared steam compressor 179, as already described above. The integrally geared steam compressor 179 is driven in rotation in this case by mechanical power provided by the steam turbine arrangement 145. Thus, part of the power converted by the steam turbine arrangement 145 from the steam into mechanical power is used to drive the integrally geared steam compressor 179 and any excess power available on the turbine shaft 151 can be converted into electric power by the electric generator 153 and delivered to the electric power distribution grid G.

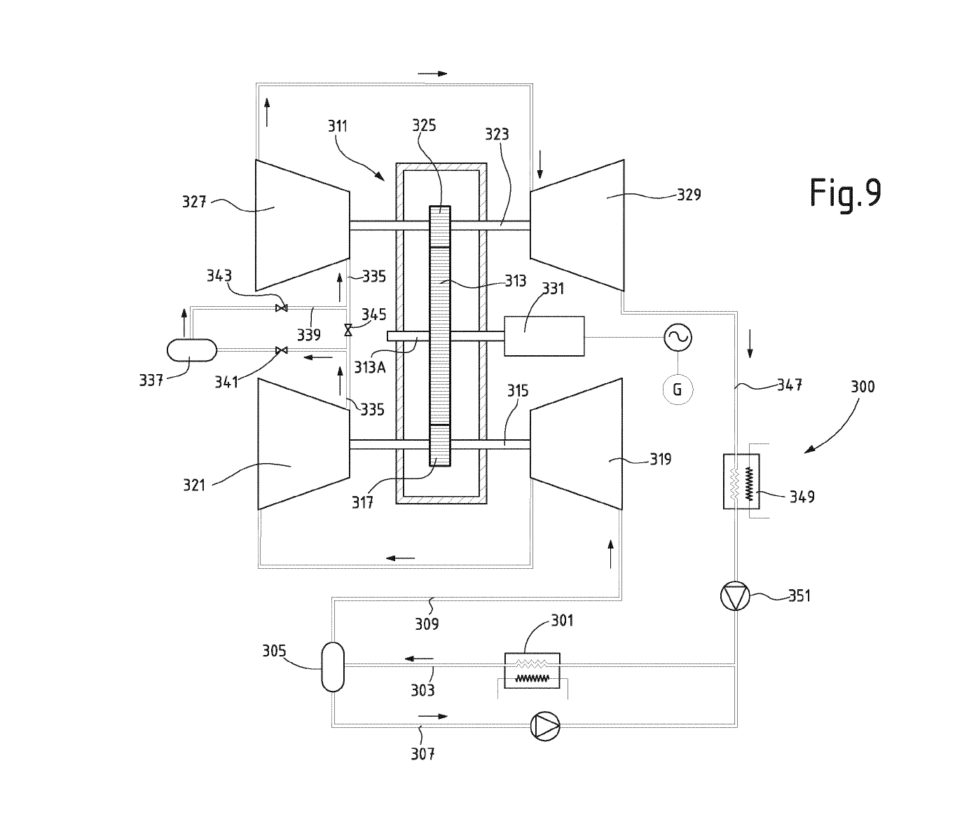

FIG. 9 illustrates a further embodiment of an arrangement according to the present disclosure. In this embodiment an integrally geared steam compressor 300 is used as a source of supplemental energy for superheating steam from a low temperature steam generator using for example heat waste from another plant, such as a gas turbine or the like.

Reference number 301 schematically illustrates a source of heat used to generate saturated or partially superheated steam, which is delivered through a steam line 303 to the integrally geared steam compressor 300. In some embodiments a water/steam separator 305 can be provided for separating water from the steam flow delivered through line 303. Water drained from the bottom of the water/steam separator 305 is recirculated from example at the inlet of the heat exchanger 301 through a return line 307. Steam from the water/steam separator 305 can be delivered through a line 309 to the integrally geared steam compressor 300.

The integrally geared steam compressor 300 can be comprised of a gear box 311 including a bull gear 313 mounted for rotation around an axis 313A. A compressor shaft 315 whereon a pinion 317 is mounted is driven into rotation by the bull gear 313. The pinion 317 meshes with the bull gear 313. In some embodiments a low-pressure compressor stage 319 and a high-pressure compressor stage 321 can be mounted on the shaft 315. One or more additional shafts driving one or more additional compressor stages can be provided.

Variable inlet guide vanes can be provided for one, some or all the compressor stages.

As in the previous embodiments, since the impellers of the compressor stage(s) are arranged in an overhung manner on the relevant shaft, variable inlet guide vanes can be easily provided at the inlet of each stage, thus allowing fine adjustment and tuning of the operating conditions of each stage, individually.

According to some embodiments, a further shaft 323 provided with a further pinion 325 is drivingly connected to the bull gear 313. The pinion 325 meshes with the bull gear 313. A high-pressure steam turbine 327 and a low-pressure steam turbine 329 can be drivingly connected to the shaft 323, so that power generated by the steam turbines 327, 329 can be used to rotate the bull gear 313. The two steam turbines 327, 329 can be arranged at opposite ends of the shaft 323. In other embodiments, only a single turbine can be provided at one end of the relevant shaft 323.

An electric generator 331 can be drivingly connected with the integrally geared steam compressor 300, so that mechanical power generated by the steam turbine(s) 327, 329 can be at least partly used to drive the electric generator and be converted into electric power. According to some embodiments, the electric generator 331 can be connected with the central shaft 313A of the bull gear 313. In other embodiments the electric generator 331 can be driven by a shaft provided with a pinion meshing with the bull gear 313.

The suction side of the low-pressure compressor stage 319 is connected to line 309 for receiving wet or saturated steam from the water/steam separator 305. Steam compressed by the low-pressure compressor stage 319 is delivered from the delivery side of said low-pressure compressor stage 319 to the suction side of the high-pressure compressor stage 321. Compressed steam is then delivered from the delivery side of the high-pressure compressor stage 321 through line 335 to the inlet of the high-pressure turbine 327, the outlet whereof is connected with the inlet of the low-pressure steam turbine 329.

In the embodiment shown in FIG. 9, the integrally geared steam compressor 300 comprises only two compressor stages 319, 321, driven by a common shaft 315, so that the impellers of the two compressor stages 319, 321 rotate at the same speed. In other embodiments, the two compressor stages 319, 321 can be driven at different speeds using separate shafts, each one being provided with a corresponding pinion meshing with the bull gear 313. The two pinions can have different diameters so that the two compressor stages can be rotated at different speeds.

In yet further embodiments, not shown, the integrally geared steam compressor 300 can be provided with more than two stages, driven by one, two or more separate shafts, each drivingly connected with the bull gear 313 with respective pinion meshing therewith, so that each compressor stage or each pair of compressor stages driven by a common shaft can rotate at different speeds. The rotary speeds of the various compressor stages can be optimized based on the compression ratio of the various stages.

In some embodiments, the delivery side of the integrally geared steam compressor 300 can be selectively connected to the turbine arrangement 327, 329 or to a superheated steam tank 337. The superheated steam tank 337 can be in turn connected through a line 339 to the inlet of the steam turbine arrangement 327, 329 and more specifically, for example (as shown in the embodiment shown in FIG. 9) with the inlet of the high-pressure steam turbine 327. A valve arrangement comprising for example valves 341, 343, 345 can be provided for controlling and adjusting the steam flow through lines 335 and 339.

The outlet of the low-pressure steam turbine 329 is connected through a line 347 with a condenser 349. Spent steam is condensed in the condenser 349 and pumped by a pump 351 to the heat exchanger 301.

The plant of FIG. 9 operates as follows. The heat source 301 generates a flow of saturated or partly superheated steam, which is delivered through line 303 in the water/steam separator 305. Steam from the water/steam separator 305 is delivered through line 309 to the low-pressure compressor stage 319. The low-pressure compressor stage 319 and the high-pressure compressor stage 321 are driven into rotation by the steam turbine arrangement 327, 329 and the mechanical power generated by the steam turbine arrangement is partly used to increase the energy content of the steam from line 309. After being processed through the compressor stages 319, 321, the steam coming from line 309 is superheated and is delivered through line 335 and valve 345 to the high-pressure steam turbine 327.

The steam is partly expanded in the high-pressure steam turbine 327 and subsequently delivered to the low-pressure steam turbine 329, where it further expands until the condenser pressure is achieved at the outlet of the low-pressure steam turbine 329.

In some embodiments, as mentioned above, only one steam turbine can be provided, for expanding the compressed superheated steam.

The power generated by the steam turbine arrangement 327, 329 is used, as mentioned above, to drive the integrally geared steam compressor 300 including the low-pressure compressor stage 319 and the high-pressure compressor stage 321. Excess power available on the shaft 323 is used to drive the electric generator 331 and is converted in electric power, which can be delivered to an electric power distribution grid G.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A power producing system, comprising:
at least one integrally geared vapor compressor arrangement, comprised of a bull gear and a compressor shaft with a pinion meshing with the bull gear;
a vapor source, fluidly connectable with an inlet of the integrally geared vapor compressor arrangement; and
at least one vapor turbine arrangement, fluidly connectable with an outlet of the integrally geared vapor compressor arrangement for receiving a stream of compressed and superheated vapor from the integrally geared vapor compressor arrangement and produce useful power.

2. The system of claim 1, further comprising an electric generator driven by the at least one vapor turbine arrangement, for converting at least part of mechanical power produced by the vapor turbine arrangement into electric power.

3. The system of claim 1, further comprising a prime mover for driving into rotation the bull gear of the integrally geared vapor compressor arrangement; wherein the prime mover preferably comprises an electric motor; and wherein the prime mover is preferably provided with a driving shaft coaxial with the bull gear.

4. The system of claim 1, wherein the vapor turbine arrangement is drivingly connected with the bull gear, such that at least a part of mechanical power produced by the vapor turbine arrangement drives into rotation the bull gear of the integrally geared vapor compressor arrangement.

5. The system of claim 1, wherein the vapor turbine arrangement comprises a high-pressure vapor turbine and a low-pressure vapor turbine.

6. The system of claim 1, wherein the vapor turbine arrangement comprises at least one turbine shaft, whereon a pinion is mounted, and wherein the pinion meshes with the bull gear.

7. The system of claim 1, wherein the vapor turbine arrangement comprises a turbine shaft coaxial with the bull gear.

8. The system of claim 7, further comprising a clutch arranged between the turbine shaft and the bull gear for selectively connecting the vapor turbine arrangement to the bull gear or disconnecting the vapor turbine arrangement from the bull gear.

9. The system of claim 2, wherein the vapor turbine arrangement comprises a main turbine drivingly connected to the electric generator and an auxiliary turbine drivingly connected to the bull gear, and wherein the vapor source is connectable with the main turbine.

10. The system of claim 1, wherein the vapor source comprises a solar collector configured and arranged for transferring solar heat to a liquid for producing vapor.

11. A concentrated solar power plant, comprising:
a solar field for collecting solar energy;
a vapor turbine system comprising a vapor turbine arrangement receiving superheated vapor generated by heating a working fluid circulating in the vapor turbine system;
a thermal transfer system configured for transferring solar thermal energy from the solar field to the vapor turbine system;
an integrally geared vapor compressor arrangement, configured for adding power to the working fluid to generate sufficient superheated vapor when the solar thermal energy from the solar field is insufficient.

12. The plant of claim 11, wherein the integrally geared vapor compressor arrangement is driven by an electric motor.

13. The plant of claim 11, wherein the integrally geared vapor compressor arrangement is driven by the vapor turbine arrangement, arranged for receiving compressed vapor from the integrally geared vapor compressor arrangement.

14. The plant of claim 11, wherein the integrally geared vapor compressor arrangement is driven by an auxiliary vapor turbine arranged for receiving compressed vapor from the integrally geared vapor compressor arrangement.

15. The plant of claim 11, comprising a high-pressure vapor accumulator, and wherein the integrally geared vapor compressor arrangement is configured for selective fluid connection with the high-pressure vapor accumulator or with the vapor turbine arrangement.

16. A method for producing useful power from heat, the method comprising:
circulating a working fluid in a closed circuit;
heating the working fluid to generate compressed vapor;
superheating the vapor by means of an integrally geared vapor compressor arrangement; and
expanding the superheated vapor in a vapor turbine arrangement and producing useful power therewith.

17. The method of claim 16, further comprising driving the integrally geared vapor compressor arrangement by means of the vapor turbine arrangement.

18. The method of claim 16, further comprising driving the integrally geared vapor compressor arrangement by means of an electric motor.

19. A method of operating a concentrated solar power plant, the method comprising:
collecting solar thermal energy with a solar field;
generating superheated vapor by heating a working fluid with the solar thermal energy;
expanding the superheated vapor in a vapor turbine arrangement and generating mechanical power therewith;
supplementing the solar thermal energy with supplemental energy delivered by an integrally geared vapor compressor arrangement for superheating vapor delivered to the vapor turbine arrangement, when the solar thermal energy is insufficient to generate sufficient superheated vapor.

20. The method of claim 19, further comprising driving the integrally geared vapor compressor arrangement by means of the vapor turbine arrangement.
